(19) United States
(12) Patent Application Publication
(10) Pub. No.: US 2006/0133853 A1
(43) Pub. Date: Jun. 22, 2006

(54) Wet-type image forming apparatus and method thereof

(75) Inventors: Hun-Sup Kim, Ansan-si (KR); Hyun-Soo Kim, Yongin-si (KR); Jong-Tae Kim, Seoul (KR); Geun-Yong Park, Suwon-si (KR); Hyeong-Ill Lee, Suwon-si (KR); Hyun-Seong Shin, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/268,483

(22) Filed: Nov. 8, 2005

(30) Foreign Application Priority Data
Dec. 22, 2004 (KR) 2004-110315

(51) Int. Cl. G03G 15/11

(52) U.S. Cl. 399/251

(57) ABSTRACT

A wet-type image forming apparatus includes an intermediate transfer medium for receiving images which are formed in a plurality of photosensitive media and overlapped thereon to form an image and transferring the image to a print medium. The intermediate transfer medium runs along a predetermined path. A drying unit heats the intermediate transfer medium to evaporate part of carrier included in the image on the intermediate transfer medium before the image is transferred onto the print medium. A cooling unit cools the heated intermediate transfer medium after the image is transferred onto the print medium by making the intermediate transfer medium directly contact a coolant.

### CROSS-REFERENCE TO RELATED APPLICATIONS

This application claims the benefit under 35 U.S.C. §119(a) of Korean Patent Application No. 2004-110315, filed on Dec. 22, 2004, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to a method and apparatus for removing liquid carrier in a wet-type image forming apparatus.

2. Description of the Related Art

A wet-type image forming apparatus uses a developer obtained by mixing toner powder of a predetermined color with a liquid-phase carrier. A wet-type electrophotographic image forming apparatus, such as a laser beam printer, forms and outputs an image by scanning a laser beam on a photosensitive medium to form an electrostatic latent image, attaching a developer to the electrostatic latent image to form a visible image, and transferring the visible image to a print medium.

FIG. 1 is an exemplary diagram of a typical wet-type electrophotographic image forming apparatus. The wet-type electrophotographic image forming apparatus includes photosensitive media 11, 12, 13, and 14, developing units 21, 22, 23, and 24, first transfer rollers 31, 32, 33, and 34, an intermediate transfer belt 50, a second transfer roller 52, a fixing unit 60, and a carrier purifying unit 70.

Electrostatic latent images are formed in the photosensitive media 11, 12, 13, and 14, and the electrostatic latent images are developed by developer provided by the developing units 21, 22, 23, and 24. The developer is formed of a toner and a liquid-phase carrier such as NORPAR®, which is a hydrocarbon-based solvent available from the Exxon Mobil Corporation of Irving, Tex.

The visible images formed by the toner on the photosensitive media 11, 12, 13, and 14 are transferred to and overlapped on the intermediate transfer belt 50 to form a full color image, and the color image is transferred onto a print medium (P).

The fixing unit 60 includes a heating roller 62 and a pressing roller 63 that contact each other with pressure, and it fixes the image onto the print medium by applying heat and pressure to the print medium with the transferred image. A pre-heater 64 heats a printing medium entering the fixing unit 60 in advance. When the print medium passes through the fixing unit 60, the toner in the developer is fixed onto the print medium and the liquid-phase carrier is evaporated by heat in the form of inflammable hydrocarbon gas, such as methane (CH₄) and exhausted outside.

Meanwhile, the inflammable hydrocarbon gas, which is classified as a volatile organic compound (VOC), contaminates the surrounding environment and emits an unpleasant odor, when it is exhausted without further processing. Therefore, it is necessary to remove the inflammable hydrocarbon gas. The carrier purifying unit 70 removes the carrier vapor by using an oxidation catalyst.

The carrier purifying unit 70 has a structure where a fan 72, a heater 73 and an oxidation catalyst filter 74 are arranged in the inside of a duct 71. One end of the duct 71 is connected to the fixing unit 60, and the other end is open to the outside. If necessary, more than one heater 73 and oxidation catalyst filter 74 can be provided. The carrier vapor produced in the fixing unit 60 flows into the duct 71 by the fan 72. It is heated to an activation temperature of approximately 200° C. while passing through the heater 73 and it enters the oxidation catalyst filter 74. The carrier vapor that has passed through the oxidation catalyst filter 74 is oxidized into harmless water and carbon dioxide and exhausted outside. While the carrier vapor is oxidized and decomposed, oxidation reaction heat is generated and the temperature in the rear end of the oxidation catalyst filter 74 is increased to about 250 to 300° C.

The high fixing temperature and the heat produced from the oxidation of the carrier vapor are transferred to adjacent elements. The heat transfer not only adversely influences image quality, but also degrades the parts of the image forming apparatus. To address these problems, a structure releasing heat by using a plurality of fans has been suggested, but it has brought about other problems. For example, such a structure makes the device bulky and causes noise and excessive power consumption for driving the fans.

Also, the high fixing temperature and the heat produced from the oxidation of the carrier vapor increases the surface temperature of the intermediate transfer belt 50 which shortens the lifespan of the intermediate transfer belt 50 and causes thermal damage to a cleaning blade 54 that cleans waste developer from the intermediate transfer belt 50.

Meanwhile, the carrier purifying unit 70 consumes excessive power to drive the fan 72 and the heater 73 and requires an expensive catalyst to process. Thus, a wet-type image forming apparatus with the carrier purifying unit 70 has a high operating cost.

When the fixing unit 60 produces too much carrier vapor for the carrier purifying unit 70 to process, unprocessed gas or incompletely oxidized gas is emitted, which leads to environmental contamination.

Accordingly, there is a need for an improved method and apparatus for processing carrier vapor in an image forming apparatus.

### SUMMARY OF THE INVENTION

An aspect of the present invention is to address at least the above problems and/or disadvantages and to provide at least the advantages described below. Accordingly, an aspect of the present invention is to provide a wet-type image forming apparatus that can reduce the quantity of carrier vapor to be processed in a fixing unit and a carrier purifying unit by removing part of carrier before image fixation, and a method of doing the same.

It is another aspect of the present invention to provide a wet-type image forming apparatus that can prevent the parts of the apparatus from degrading due to heat by using a structure that cools elements efficiently, such as a structure that cools an intermediate transfer belt efficiently, and a method of doing the same.

In accordance with an aspect of the present invention, a wet-type image forming apparatus includes an intermediate transfer medium. The intermediate transfer medium receives images which are formed on at least one photosensitive medium, and transferred the received images to a print medium. The intermediate transfer medium runs along a predetermined path. A drying unit heats the intermediate transfer medium to evaporate part of the carrier included in the image on the intermediate transfer medium before the image is transferred onto the print medium. A cooling unit cools the heated intermediate transfer medium after the image is transferred onto the print medium by making the intermediate transfer medium directly contact a coolant.

The drying unit may includes a dryer for generating heat, a condenser for liquefying carrier vapor obtained from evaporation by the dryer, and a fan for forcibly transferring the carrier vapor to the condenser.

Also, the wet-type image forming apparatus may further includes a squeeze roller for squeezing out a carrier component from the image on the intermediate transfer medium to remove a portion of the carrier component. The squeeze roller may be disposed in an area before the drying unit.

The cooling unit may include a coolant container for storing a coolant, and part of the intermediate transfer medium may be sunk into the coolant of the coolant container to cool the intermediate transfer medium.

The cooling unit may further include a coolant remover for removing coolant adhering to the intermediate transfer medium coming out of the coolant container.

The coolant may have the same composition as the carrier of the developer.

The cooling unit may further include a cooler for cooling the coolant of the coolant container, and a pump for transferring the coolant to the cooler and supplying the cooled coolant back to the coolant container.

The cooling unit may be disposed in the coolant container to contact the intermediate transfer medium, and the cooling unit may further include a cleaner for removing waste toner from the intermediate transfer medium.

The cooling unit may be disposed between the coolant container and the cooler, and the cooling unit may further include a filter for filtering out impurities included in the coolant from the coolant container.

In accordance with another aspect of the present invention, a wet-type image forming apparatus includes an image forming unit including at least one photosensitive medium and at least one developing unit. An intermediate transfer belt receives images which are transferred from the photosensitive medium to form a received image. The intermediate transfer belt travels in an endless loop and the photosensitive media is disposed on the circumference of the intermediate transfer belt. A drying unit heats the intermediate transfer medium to evaporate a carrier in the image formed on the intermediate transfer belt. A transferring and fixing unit transfers and fixes the image whose carrier is partially removed onto a print medium. A cooling unit cools the intermediate transfer medium by making the intermediate transfer medium directly contact a coolant. A carrier purifying unit oxidizes and exhausts carrier vapor generated during the transferring and fixing processes by using a catalyst such as an oxidation catalyst filter.

In accordance with yet another aspect of the present invention, a wet-type image forming method includes the steps of forming visible images by developing electrostatic latent images formed on at least one photosensitive media with a liquid-phase developer and transferring the developed image to an intermediate transfer medium to form a transferred image, squeezing carrier in the transferred image to remove a portion of the carrier, heating the intermediate transfer medium to evaporate the carrier in the transferred image and thereby remove additional carrier, transferring and fixing the image whose carrier component is partially removed from the intermediate transfer medium onto a print medium, purifying carrier vapor generated during the fixation process based on a catalytic reaction, and cooling the intermediate transfer medium.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is an exemplary diagram showing a typical wet-type image forming apparatus;

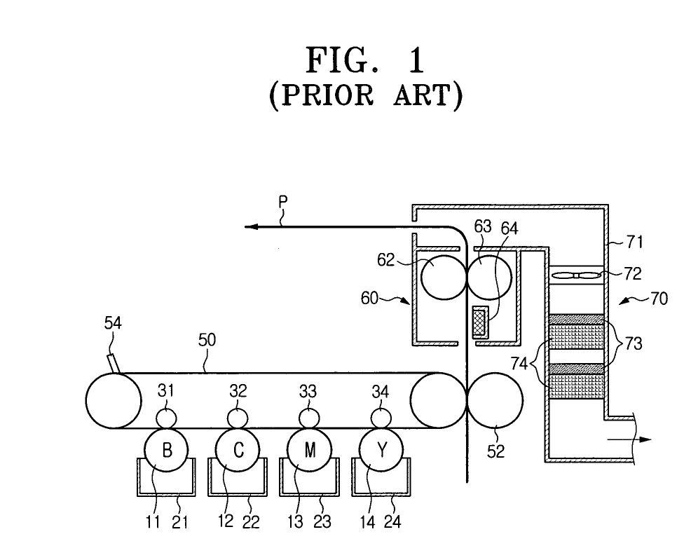

FIG. 2 is a schematic view of a wet-type image forming apparatus in accordance with an exemplary embodiment of the present invention; and

FIG. 3 is a flowchart of an image forming method using a wet-type image forming apparatus in accordance with an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

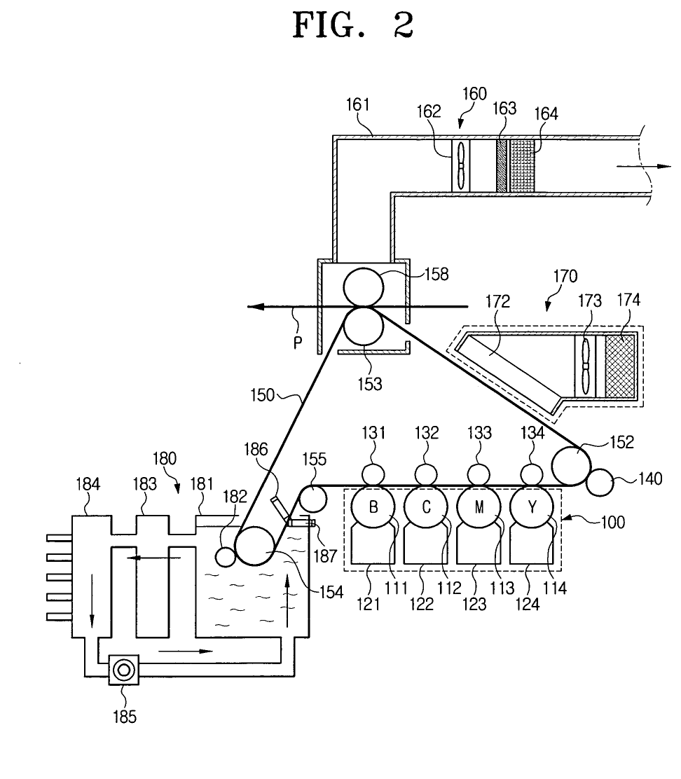

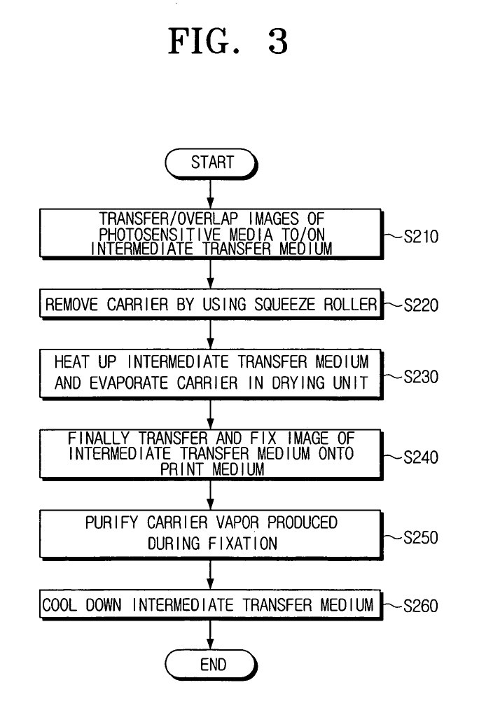

FIG. 2 is a schematic view of a wet-type image forming apparatus in accordance with an exemplary embodiment of the present invention, and FIG. 3 is a flowchart describing an image forming method using a wet-type image forming apparatus in accordance with an exemplary embodiment of the present invention.

Referring to FIG. 2, the wet-type image forming apparatus includes an image forming unit 100, a transfer unit including an intermediate transfer medium 150, a squeeze roller 140, a drying unit 170, a cooling unit 180, and a carrier purifying unit 160.

The image forming unit 100 includes four photosensitive media 111, 112, 113 and 114 and four developing units 121, 122, 123 and 124. Each of the media and each developing unit is preferably assigned to one color, for example, black (B), cyan (C), magenta (M) and yellow (Y). In each of the photosensitive media 111, 112, 113 and 114, a predetermined electrostatic latent image is formed, and the developing units 121, 122, 123 and 124 provide developers to the electrostatic latent images of the photosensitive media 111, 112, 113 and 114 to develop the electrostatic latent images into visible images, respectively. Each developer is formed of powder toner for forming an image and liquid-phase carrier for transferring the toner smoothly during development and transfer. As for the liquid-phase carrier, hydrocarbon-based solvents such as NORPAR® or ISOPAR® (available from the Exxon Mobil Corporation of Irving, Tex.) are used.

The transfer unit includes a plurality of first transfer rollers 131, 132, 133 and 134 for transferring the visible images formed in the photosensitive media 111, 112, 113 and 114 onto the intermediate transfer medium, an intermediate transfer belt 150, which is the intermediate transfer medium where the visible images are transferred and overlapped, and a second transfer roller 158 for transferring the final image formed on the intermediate transfer belt 150 into supplied paper (P).

The intermediate transfer belt 150 is supported by a plurality of backup rollers 152, 152, 154 and 155 and circulates infinitely in the form of a closed loop along a predetermined running path. The backup rollers include a driving roller for driving the intermediate transfer belt 150, a steering roller for controlling the tension of the intermediate transfer belt 150, and a path correcting roller for adjusting the path of the intermediate transfer belt 150 to pass through a coolant container 181, which will be described later. The squeeze roller 140 is disposed to contact a first backup roller 152 face to face with the intermediate transfer belt 150 between them and squeezes out a predetermined quantity of carrier in the image formed on the intermediate transfer belt 150. Preferably, the quantity of the carrier squeezed out by the squeeze roller 140 is controlled within a predetermined range so that the intermediate transfer belt 150 is not damaged and the image on the intermediate transfer belt 150 is not affected when it is finally transferred onto paper. The quantity of carrier squeezed out can be controlled by adjusting the contact pressure of the squeeze roller 140. Part of the running path of the intermediate transfer belt 150 passes through the coolant container 181 in the cooling unit 180. For this, a third backup roller 154 is disposed in the inside of the coolant container 181.

The second transfer roller 158 is disposed to contact a second backup roller 153 face to face with the intermediate transfer belt 150 between them to transfer the image on the intermediate transfer belt 150 onto the paper (P). The second transfer roller 158 can also be utilized as a fixing roller. In this case, a heating source such as a heating lamp is provided inside the second transfer roller 158. The second transfer roller 158 with the heating source functions as a transfer and fixing roller that applies heat and pressure while transferring the image from the intermediate transfer belt 150. Therefore, the image transferred onto the paper is fixed by the heat and pressure. During fixation, the toner is fixed on the paper and the carrier is evaporated by the heat.

The drying unit 170 is disposed between the squeeze roller 140 and the second transfer roller 158 in the running path of the intermediate transfer belt 150 and heats the intermediate transfer belt 150 holding the image. The drying unit 170 includes a dryer 172, a condenser 174, and a fan 173. The dryer 172 evaporates a predetermined quantity of the carrier in the image held on the intermediate transfer belt 150 by applying heat to the intermediate transfer belt 150. The dryer 172 provides heat to the intermediate transfer belt 150 by setting up a heat source, such as a heater, in front of the intermediate transfer belt 150 directly or supplies heat from a heat source to the intermediate transfer belt 150 by using an air blower. Some of the carrier in the image on the intermediate transfer belt 150 is evaporated by the heat produced in the dryer 172. The condenser 174 entraps and liquefies the carrier vapor generated from the evaporation by the dryer 172. Then, the fan 173 provides the carrier vapor to the condenser 174.

As shown above, the squeeze roller 140 and the drying unit 170 remove part of the carrier in the image held on the intermediate transfer belt 150 before the image is transferred onto paper. This way, it is possible to reduce the quantity of carrier vapor produced during fixation and process a substantial amount (preferably, almost 100%) of the carrier. Herein, the removal of the carrier by the squeeze roller 140 has its limit, but the carrier in the image on the intermediate transfer belt 150 can be removed sufficiently by the drying unit 170 within the range that the carrier removal does not affect the transfer of the image. Since the quantity of the carrier to be removed in the transfer and fixation processes is reduced, the power consumption required for processing the carrier is reduced and the size of a device for cooling the high-temperature carrier vapor is decreased. Meanwhile, it is important to control the quantity of the carrier evaporated by the drying unit 170 appropriately within the range that the carrier reduction does not affect the final transfer of the image to paper by the second transfer roller 158. For example, it is preferred that the dryer 172 heats the intermediate transfer belt 150 until the surface temperature of the intermediate transfer belt 150 becomes approximately 120° C.

The carrier purifying unit 160 purifies and removes the carrier vapor produced during fixation by using an oxidation catalyst. The carrier vapor generated during the fixation process is sucked in by a fan 162 into the duct 161. The sucked carrier vapor passes through a heater 163 to be heated to an activation temperature. Then, the carrier vapor is oxidized and decomposed into innocuous water and carbon dioxide as it passes through an oxidation catalyst filter 164. The water and carbon dioxide are exhausted out of the duct 61, that is, the image forming apparatus. As described above, in the present embodiment, since the quantity of the carrier in the image finally transferred to paper is reduced, the quantity of the carrier vapor to be processed in the carrier purifying unit 160 is reduced. Therefore, the number of the heaters 163 and the oxidation catalyst filters 164 can be reduced in the image forming apparatus of the present invention, compared to conventional image forming apparatuses.

The cooling unit 180 is disposed in the running path of the intermediate transfer belt 150 behind an area where the image on the intermediate transfer belt 150 is transferred to the print medium and it cools the intermediate transfer belt 150 which has been heated by the drying unit 170. As shown in the drawing, the cooling unit 180 includes a coolant container 181, a cooler 184, a filter 183, a pump 185, and coolant removers 186 and 187.

The coolant container 181 stores a coolant for cooling the intermediate transfer belt 150. As illustrated in the drawing, the coolant container 181 is disposed in the running path of the intermediate transfer belt 150 so that the intermediate transfer belt 150 can pass through the coolant container 181. As the intermediate transfer belt 150 passes through the coolant container 181, it directly contacts the coolant and thus the high-temperature intermediate transfer belt 150 is cooled to room temperature in a short time. Preferably, the coolant in the coolant container 181 has the same composition as the carrier composition included in the developer, that is, a hydrocarbon-based solvent such as NORPAR® or ISOPAR®.

Meanwhile, a cleaning roller 182 is disposed in the coolant container 181 to remove waste toner remaining on the intermediate transfer belt 150. The cleaning roller 182 is disposed to contact a third backup roller 154 face to face with the intermediate transfer belt 150 between them and removes the waste toner on the intermediate transfer belt 150 by squeezing the intermediate transfer belt 150. Although not illustrated in the drawing, it is possible to use a blade instead of the cleaning roller 182. Placing the cleaning roller 182 inside the coolant container 181, which is suggested in the present exemplary embodiment, improves the cleaning performance. Generally, some of the waste toner remaining in the intermediate transfer belt 150 after an image has been transferred is solidified and removal is difficult. However, with the present exemplary embodiment, the waste toner on the intermediate transfer belt 150 is partially liquefied by a carrier which is a coolant and easily cleaned by the cleaning roller 182.

The cooler 184 cools the coolant whose temperature is increased by the high-temperature intermediate transfer belt 150 to room temperature. The cooler 184 may be any desired structure, material or shape.

The filter 183 is disposed between the coolant container 181 and the cooler 184 and separates and filters impurities and toner residue contained in the coolant stored in the coolant container 181 before the coolant is provided to the cooler 184. Therefore, the coolant can be maintained clean by the filter 183 and used repeatedly for a long period.

The pump 185 transfers the coolant in the coolant container 181 into the cooler 184, and forces the coolant cooled by the cooler 184 to circulate into the coolant container 181 again.

The coolant removers 186 and 187 remove coolant adhering to the surface of the intermediate transfer belt 150 due to the passage of the intermediate transfer belt 150 through the coolant container 181. As shown in the drawing, it is preferable to set up two coolant removers 186 and 187 in order to remove the coolant adhering to both sides of the intermediate transfer belt 150. The coolant removers 186 and 187 are disposed to contact and apply a predetermined level of pressure to both sides of the intermediate transfer belt 150. Also, the coolant removers 186 and 187 are disposed in the upper part of the coolant container 181 so that the coolant removed from the surface of the intermediate transfer belt 150 by the coolant removers 186 and 187 can go back into the coolant container 181. When constructed in this manner, a separate, additional chamber for collecting the removed coolant is not necessary.

With reference to FIGS. 2 and 3, a method for removing the carrier and cooling the intermediate transfer belt 150 in the wet-type image forming apparatus will be described hereafter in accordance with an exemplary embodiment of the present invention.

When the image forming apparatus begins a printing operation, a laser beam is irradiated from a light source (not shown) onto the surfaces of the photosensitive media 111, 112, 113 and 114 which are charged to have a predetermined level of potential by a charger (not shown). As the potential changes, an electrostatic latent image is formed on the surface of each photosensitive media 111, 112, 113 or 114 irradiated with the laser beam. Then, the developing units 121, 122, 123 and 124 attach developers of black (B), cyan (C), magenta (M) and yellow (Y) to the electrostatic latent images formed in the photosensitive media 111, 112, 113 and 114, respectively, to form visible images. The visible images of the four colors are sequentially transferred to the intermediate transfer belt 150 by the first transfer rollers 131, 132, 133 and 134, respectively. At step S210, a color image obtained as the developers of the four colors are overlapped is formed in the intermediate transfer belt 150.

At step S220, the color image formed in the intermediate transfer belt 150 is squeezed by the squeeze roller 140 and thus some of the carrier in the color image is removed. At step S230, the intermediate transfer belt 150 which has passed through the squeeze roller 140 goes through the drying unit 170 where part of the carrier in the image is dried and evaporated. That is, some of the carrier in the image on the intermediate transfer belt 150 is evaporated by the dryer 172 and the carrier vapor is transferred by the fan 173 to the condenser 174 and liquefied.

While a series of the image forming process is carried out, a paper feeding device (not shown) transfers paper (P) to the second transfer roller 158. When the paper (P) is transferred between the intermediate transfer belt 150 and the second transfer roller 158, the second transfer roller 158 transfers and fixes the color image held on the intermediate transfer belt 150 onto the paper (P). At step S240, the carrier of the developer composition transferred onto the paper is evaporated by heat and pressure generated in the second transfer roller 158 and the toner is fixed onto the paper.

At step S250, the carrier vapor generated during the fixation is purified by the carrier purifying unit 160 and exhausted out of the image forming apparatus. Before the exhaustion, the high-temperature gas is cooled by a plurality of coolers (not shown), such as fans.

As described above, since the carrier in the image held on the intermediate transfer belt 150 is partially removed by the squeeze roller 140 and then partially removed by the drying unit 170 in advance of fixation, the quantity of the carrier vapor generated during fixation is reduced. Therefore, the carrier purifying unit 160 illustrated in the exemplary embodiment of the present invention can be smaller than conventional purifying units, because the purifying unit handles a smaller quantity of the carrier vapor. Also, the reduction of the carrier can reduce the heating temperature of the second transfer roller 158 during fixation, thereby decreasing power consumption and fixation time.

When the image on the intermediate transfer belt 150 is transferred onto the paper, at step S260, the intermediate transfer belt 150 continues to run and is cooled as it passes through the cooling unit 180. Hereafter, the cooling of the intermediate transfer belt 150 will be described in further detail.

While running along a predetermined path, the intermediate transfer belt 150 enters the coolant container 181. The high-temperature intermediate transfer belt 150 which has been heated by the drying unit 170 and the second transfer roller 158 is cooled by directly contacting the coolant stored in the coolant container 181. In contrast, the temperature of the coolant contacting the intermediate transfer belt 150 is increased. Meanwhile, waste toner on the intermediate transfer belt 150 which is not transferred to the paper is removed by the cleaning roller 182. When the intermediate transfer belt 150 passes through the coolant container 181 to be cooled and passes out of the coolant container 181, the coolant adheres to the surfaces of the intermediate transfer belt 150. The coolant removers 186 and 187 remove the coolant adhering to the surfaces of the intermediate transfer belt 150. The intermediate transfer belt 150 exiting the coolant container 181 enters the photosensitive media again and repeats the development and transferring processes.

Meanwhile, the pump 185 circulates the coolant of the coolant container 181 through the filter 183 and the cooler 184 and sends the coolant back to the coolant container 181 repeatedly. When the coolant passes through the filter 183, impurities included in the coolant, such as waste toner removed by the cleaning roller 182, are filtered out. The temperature of the coolant that has passed through the filter 183 is decreased as the coolant goes through the cooler 184. The pump 185 sends the cooled coolant back to the coolant container 181.

As described above, according to the wet-type image forming apparatus and method of the present invention, the quantities of the carrier and carrier vapor to be removed during fixation are reduced, as the carrier in the image held on the intermediate transfer medium is partially removed by the squeeze roller before the final transfer of the image into the print medium and then partially removed by the drying unit. Therefore, it is possible to reduce the quantity of the oxidation catalyst for processing the carrier vapor which is generated in a large quantity during fixation in the conventional image forming apparatuses, decrease the power consumption, and reduce the size of the cooler.

It is also possible to quickly cool the intermediate transfer medium by making the heated intermediate transfer medium pass through the coolant container and directly contact the coolant. The fast cooling speed is directly related to the mechanical properties of the intermediate transfer medium and can help extend the lifespan of the intermediate transfer medium.

Also, the setup of the filter maintains the coolant clean so that the coolant can be used repeatedly.

Since a cleaner for removing waste toner which is not transferred to the print medium is placed inside the coolant container, the cleaning efficiency is improved.

While the invention has been shown and described with reference to certain embodiments thereof, it will be understood by those skilled in the art that various changes in form and details may be made therein without departing from the spirit and scope of the invention as defined by the appended claims.

What is claimed is:

1. A wet-type image forming apparatus, comprising:
an intermediate transfer medium for receiving an image which is formed on at least one photosensitive medium, and for transferring the image to a print medium;
a drying unit for heating the intermediate transfer medium to evaporate part of carrier included in the image on the intermediate transfer medium before the image is transferred onto the print medium; and
a cooling unit for cooling the heated intermediate transfer medium after the image is transferred onto the print medium by making the intermediate transfer medium directly contact a coolant.

2. The apparatus as recited in claim 1, further comprising:
a plurality of photosensitive media which form images in different color and transfer the different color images to the intermediate transfer medium in an overlapped manner to form complete color images.

3. The apparatus as recited in claim 1, wherein
the intermediate transfer medium runs along a predetermined path.

4. The apparatus as recited in claim 1, wherein the drying unit includes:
a dryer for generating heat;
a condenser for liquefying carrier vapor obtained by evaporation; and
a fan for forcibly transferring the carrier vapor to the condenser.

5. The apparatus as recited in claim 1, further comprising:
a squeeze roller for squeezing out a carrier component from the image on the intermediate transfer medium to remove the carrier component, the squeeze roller being positioned in an area before the drying unit.

6. The apparatus as recited in claim 1, wherein the cooling unit includes:
a coolant container for storing a coolant, and part of the intermediate transfer medium is sunk in the coolant of the coolant container to cool the intermediate transfer medium.

7. The apparatus as recited in claim 6, wherein the cooling unit further includes:
a coolant remover for removing coolant that adheres to the intermediate transfer medium coming out of the coolant container.

8. The apparatus as recited in claim 6, wherein
the coolant is the same composition as the carrier of a developer.

9. The apparatus as recited in claim 6, wherein the cooling unit further includes:
a cooler for cooling the coolant of the coolant container; and
a pump for transferring the coolant to the cooler and supplying the cooled coolant back to the coolant container.

10. The apparatus as recited in claim 9, wherein the cooling unit further includes:
a cleaner disposed in the coolant container to remove waste toner from the intermediate transfer medium.

11. The apparatus as recited in claim 9, wherein the cooling unit further includes:
a filter disposed between the coolant container and the cooler to filter out impurities included in the coolant from the coolant container.

12. A wet-type image forming apparatus, comprising:
an image forming unit including at least one photosensitive medium and at least one developing unit;
an intermediate transfer belt for receiving an image which is transferred from the photosensitive medium;
a squeeze roller for squeezing out a carrier component from the image on the intermediate transfer belt and removing at least a portion of the carrier component;
a drying unit for heating the intermediate transfer belt to evaporate the carrier component in the image formed on the intermediate transfer belt and thereby remove a further portion of the carrier component;
a transferring and fixing unit for transferring and fixing the image whose carrier is partially removed onto a print medium;
a cooling unit for cooling the intermediate transfer belt by making the intermediate transfer belt directly contact a coolant; and
a carrier purifying unit for oxidizing and exhausting carrier vapor generated during the transferring and fixing processes by using an oxidation catalyst filter.

13. The apparatus as recited in claim 10, wherein the image forming unit includes:
a plurality of photosensitive media which form images in different color and transfer the different color images to the intermediate transfer belt in an overlapped manner to form complete color images.

14. The apparatus as recited in claim 12, wherein the drying unit includes:
a dryer for generating heat;
a condenser for liquefying carrier vapor obtained from evaporation by the dryer; and
a fan for forcibly transferring the carrier vapor to the condenser.

15. The apparatus as recited in claim 12, wherein the cooling unit includes:
a coolant container for storing a coolant in which part of the intermediate transfer belt is immersed;
a cooler for cooling the coolant stored in the coolant container; and
a circulating pump for transferring the coolant to the cooler and supplying coolant cooled by the cooler back to the coolant container.

16. The apparatus as recited in claim 14, wherein the cooling unit further includes:
a coolant remover for removing coolant adhering to the intermediate transfer belt coming out of the coolant container;
a cleaner for removing waste toner from the intermediate transfer belt, the cleaner being disposed in the the coolant container to contact the intermediate transfer belt; and
a filter for filtering out impurities in the coolant coming out of the coolant container, the filter being disposed between the coolant container and the cooler.

17. The apparatus as recited in claim 14, wherein
the coolant has the same composition as the carrier of a developer.

18. A wet-type image forming method, comprising the steps of:
a) forming visible images by developing electrostatic latent images formed on at least one photosensitive medium with a liquid-phase developer;
b) transferring the visible image from the photosensitive medium to an intermediate transfer medium to form an image;
c) squeezing carrier in the image on the intermediate transfer medium to remove a portion of the carrier;
d) heating the intermediate transfer medium to evaporate the carrier in the image on the intermediate transfer medium and thereby remove additional carrier;
e) transferring and fixing the image whose carrier component is partially removed from the intermediate transfer medium onto a print medium;
f) purifying carrier vapor generated during the fixation process; and
g) cooling the intermediate transfer medium.

19. A wet-type image forming method according to claim 18, wherein
step a) includes the step of forming a plurality of single color visible images by developing electrostatic latent images formed on a plurality of photosensitive media with a liquid-phase developer, and
step b) includes the step of transferring and overlapping the plurality of visible images to an intermediate transfer medium to form a full color image.

20. A wet-type image forming method according to claim 18, wherein
in step f), the carrier vapor is purified by a catalytic oxidation reaction
